(19) United States
(12) Patent Application Publication
(10) Pub. No.: US 2023/0327186 A1
(43) Pub. Date: Oct. 12, 2023

(54) SULFIDE-BASED SOLID ELECTROLYTE, METHOD FOR PREPARING SAME, AND ELECTROCHEMICAL CELL COMPRISING SAME

(71) Applicant: SAMSUNG SDI CO., LTD., Yongin-si, Gyeonggi-do (KR)

(72) Inventors: Soyeon KIM, Suwon-si, Gyeonggi-do (KR); Dongjin LEE, Suwon-si, Gyeonggi-do (KR); Hyunseok KIM, Suwon-si, Gyeonggi-do (KR); Saebom RYU, Suwon-si, Gyeonggi-do (KR)

(21) Appl. No.: 18/013,996

(22) PCT Filed: Jul. 29, 2021
(86) PCT No.: PCT/KR2021/009907

§ 371 Date: Dec. 30, 2022

(30) Foreign Application Priority Data
Sep. 15, 2020 (KR) 10-2020-0118506

(51) Int. Cl. H01M 10/0562; H01M 4/58; H01M 4/04; H01M 4/38; H01M 4/40; H01M 4/583; H01M 4/36

(52) U.S. Cl. CPC H01M 10/0562; H01M 4/0404; H01M 4/366; H01M 4/382; H01M 4/405; H01M 4/5815; H01M 4/583; H01M 2004/021

(57) ABSTRACT

Disclosed are a method of preparing a sulfide solid electrolyte, a sulfide solid electrolyte prepared by the method, and an electrochemical cell comprising the sulfide solid electrolyte, the method comprising: preparing a precursor mixture by mixing raw materials with an organic compound, wherein the raw materials are for forming a sulfide solid electrolyte containing lithium, and the organic compound is non-reactive with lithium and is a non-ionic material having a hydrophobic region and a hydrophilic region; removing a solvent from the precursor mixture; and performing heat-treatment on the resultant product having the solvent removed therefrom.

### TECHNICAL FIELD

The present disclosure relates to a sulfide solid electrolyte, a method of preparing the same, and an electrochemical cell comprising the sulfide solid electrolyte.

### BACKGROUND ART

Recently, batteries having high energy density and increased safety are being actively developed in response to industrial demand. For example, lithium-ion batteries have been put into practical use in automobiles as well as in the fields of information-related appliances and communication devices. In the automobile field, safety is a particularly important issue because automobiles may have a critical impact on people’s lives.

Since currently commercially available lithium-ion batteries use an electrolytic solution containing a combustible organic solvent, there is a possibility of overheating and the occurrence of a fire when a short circuit occurs. In this regard, an all-solid battery using a solid electrolyte, instead of an electrolytic solution, has been proposed.

An all-solid battery does not use a combustible organic solvent, and thus, even when a short circuit occurs, the likelihood of a fire or an explosion can be considerably reduced. Therefore, an all-solid battery can greatly increase safety, as compared with a lithium-ion battery.

As a solid electrolyte of an all-solid battery, a sulfide solid electrolyte having high ionic conductivity is used.

The sulfide solid electrolyte may be prepared by a solid-phase synthesis method or a solution-phase synthesis method. When the sulfide solid electrolyte is prepared by a solid-phase synthesis method, particle agglomeration is observed, indicating that a particle size distribution is extremely uneven and the manufacturing time is prolonged. In addition, with a solid-phase synthesis method, a substantial amount of energy is required, which is a limitation on scale-up and makes large-scale production difficult, and thus there is a need for an improved sulfide solid electrolyte.

### DESCRIPTION OF EMBODIMENTS

### Technical Problem

An aspect is to provide a method of preparing a sulfide solid electrolyte.

Another aspect is to provide a sulfide solid electrolyte prepared by the method and thus having improved particle size distribution characteristics.

Still another aspect is to provide an electrochemical cell having improved cell performance by including the sulfide solid electrolyte.

### Solution to Problem

According to an aspect, provided is a method of preparing a sulfide solid electrolyte, the method comprising: preparing a precursor mixture by mixing raw materials for forming a sulfide solid electrolyte containing lithium with an organic compound, wherein the organic compound is non-reactive with lithium and is a non-ionic material having a hydrophobic region and a hydrophilic region; removing a solvent from the precursor mixture; and performing heat-treatment on the resultant product having the solvent removed therefrom.

According to another aspect, provided is a sulfide solid electrolyte including a compound represented by Formula 1 below and having an argyrodite crystal structure, wherein the compound has a D50 of 0.9 µm to 5.0 µm, a D10 of 0.1 µm to 0.8 µm, and a D90 of 3 µm to 20 µm:

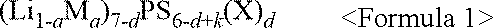

wherein, in Formula 1, M is sodium (Na), potassium (K), calcium (Ca), iron (Fe), magnesium (Mg), silver (Ag), zirconium (Zr), zinc (Zn) or a combination thereof,
X is chlorine (Cl), bromine (Br), fluorine (F), iodine (I), a pseudohalogen or a combination thereof,
0<x<1, 0≤a<1, 0<d≤1.8, and O≤k<1.

According to still another aspect, provided is an electrochemical cell including: a cathode layer; an anode layer; and a solid electrolyte layer positioned between the cathode layer and the anode layer, wherein at least one selected from the cathode layer; the anode layer; and the solid electrolyte layer includes the sulfide solid electrolyte.

### BRIEF DESCRIPTION OF DRAWINGS

The above and other aspects, features, and advantages of certain embodiments of the disclosure will be more apparent from the following description taken in conjunction with the accompanying drawings, in which:

FIGS. 1 and 2 are scanning electron microscope views of sulfide solid electrolytes prepared in Example 1 and Comparative Example 1, respectively;

FIG. 3 shows X-ray diffraction spectra of sulfide solid electrolytes prepared in Example 1 and Comparative Example 1, respectively;

FIG. 4 shows particle distribution characteristics of sulfide solid electrolytes prepared in Example 1 and Comparative Example 1, respectively;

FIG. 4 shows Raman spectra of sulfide solid electrolytes prepared in Examples 1 to 3 and Comparative Examples 1 and 2; and

FIGS. 6 to 8 are cross-sectional views of all-solid secondary batteries according to exemplary embodiments.

Explanation of Reference numerals designating the Major Elements of the Drawings

| | |
|---|---|
| 1: Solid secondary battery | 10: Cathode layer |
| 11: Cathode current collector | 12: Cathode active material layer |
| 20: Anode layer | 21: Anode current collector |
| 22: Anode active material layer | 30: Solid electrolyte |

### MODE OF DISCLOSURE

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

A sulfide solid electrolyte according to an embodiment, a method of preparing the same, and an electrochemical cell comprising the sulfide solid electrolyte will now be described in further detail.

Provided is a sulfide solid electrolyte including a compound represented by Formula 1 below and having an argyrodite crystal structure, wherein the compound has a D50 of 0.9 µm to 5.0 µm, a D10 of 0.1 µm to 0.8 µm, and a D90 of 3 µm to 20 µm:

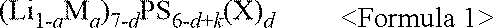

wherein, in Formula 1, M is sodium (Na), potassium (K), calcium (Ca), iron (Fe), magnesium (Mg), silver (Ag), zirconium (Zr), zinc (Zn), or a combination thereof, X is chlorine (Cl), bromine (Br), fluorine (F), iodine (I), a pseudohalogen, or a combination thereof, 0<x<1, 0≤a<1, 0<d≤1.8, and O≤k<1.

Dmin to Dmax of the compound may be, for example, in a range of 0.079 µm to 15.56 µm. Here, Dmin represents a minimum particle diameter of the compound and Dmax represents a maximum particle diameter of the compound.

When the sulfide solid electrolyte is prepared by a general solution synthesis method, raw materials for forming a sulfide solid electrolyte are mixed with an organic solvent, stirred and reacted, followed by performing heat treatment. The sulfide solid electrolyte prepared by the solution-phase synthesis method is easy to scale-up, consumes a small amount of energy, shortens a reaction time, and can reduce manufacturing costs. Compared with the sulfide solid electrolyte prepared by the solid-phase synthesis method, it is observed that particles of the sulfide solid electrolyte prepared by the solution-phase synthesis method agglomerate together, forming a network shape, even though the particles are very small and uniformly distributed, and thus a need for an improved sulfide solid electrolyte still remains.

Accordingly, the present inventors completed, by solving the above-mentioned drawbacks, a method for preparing a sulfide solid electrolyte, having a small particle size, a uniform distribution with little agglomeration and a high ionic conductivity, and a sulfide solid electrolyte prepared by the method.

The sulfide solid electrolyte according to an embodiment is stable at a high voltage, and use of the sulfide solid electrolyte may reduce a side reaction during an interfacial reaction between a cathode layer and an electrolyte layer, thereby manufacturing an electrochemical cell having an increased discharge capacity and improved cycle characteristics.

Hereinafter, a method of preparing the sulfide solid electrolyte according to an embodiment will be described.

To obtain a sulfide solid electrolyte, first, the method includes preparing a precursor mixture by mixing raw materials for forming a sulfide solid electrolyte containing lithium with an organic compound, wherein the organic compound is non-reactive with lithium and is a non-ionic material having a hydrophobic region and a hydrophilic region. Next, the method includes removing a solvent from the obtained precursor mixture, and then performing heat treatment on the resultant product having the solvent removed therefrom, thereby obtaining the sulfide solid electrolyte.

The removing of the solvent from the precursor mixture may be performed using a rotary evaporator, etc.

In providing the precursor mixture, if an organic compound which is non-reactive with lithium and is a non-ionic material having a hydrophobic region and a hydrophilic region, is added, the raw materials are uniformly dispersed and mixed, so that reactions are performed under the optimum conditions, thereby easily providing the sulfide solid electrolyte having a narrow particle size distribution and relatively small particle sizes without particle agglomeration, as compared with the sulfide solid electrolyte prepared by the general solution-phase synthesis method. Compared to the solid-phase synthesis method, this method does not require high energy, shortens the manufacturing time, reduces manufacturing costs, and is easy to scale-up for large-scale production.

The raw materials for forming the sulfide solid electrolyte includes sulfur (S) precursor, phosphorus (P) precursor, and a halogen X precursor to obtain the sulfide solid electrolyte including the compound of Formula 1, and X in the halogen X precursor includes chlorine (Cl), bromine (Br), fluorine (F), iodine (I), a pseudohalogen, and a combination thereof.

The organic compound which is non-reactive with lithium and is a non-ionic material having a hydrophobic region and a hydrophilic region, is a non-ionic compound having a polyethylene oxide-based unit.

The compound may be a non-ionic surfactant.

The organic compound is a non-ionic compound and may have a hydroxide group (—OH), an ether bond (—O—), an amide bond (—CONH—), or an ester bond (-COOR), which is not dissociated into an ion, in the molecule thereof. In addition, a hydrophile-lipophile balance (HLB) value of the non-ionic compound is in a range of 4 to 18. If the HLB value of the non-ionic compound is 20, the non-ionic compound has a highly lipophilic property, and if the HLB value is 0, the non-ionic compound has a highly hydrophilic property.

The organic compound may include, for example, octoxinol, polyoxyethylene sorbitan fatty acid ester, polyoxyethyleneglycol ether, or a combination thereof.

In the present specification, the polyoxyethylene ether may include polyoxyethylene (4) lauryl ether, polyoxyethylene (23) lauryl ether, polyoxyethylene (2) cetyl ether, polyoxyethylene (10) cetyl ether, polyoxyethylene (20) cetyl ether, polyoxyethylene (2) stearyl ether, polyoxyethylene (10) stearyl ether, polyoxyethylene (20) stearyl ether, polyoxyethylene (2) oleyl ether, polyoxyethylene (2) oleyl ether, polyoxyethylene (10) oleyl ether, polyoxyethylene (20) oleyl ether, polyoxyethylene (100) stearyl ether, or a combination thereof.

The polyoxyethylene sorbitan fatty acid ester may be polyoxyethylene (20) sorbitan monolaurate, polyoxyethylene (20) sorbitan monopalmitate, polyoxyethylene sorbitan monostearate, polyoxyethylene sorbitan tristearate, polyoxyethylene(20)sorbitan monooleate, polyoxyethylene sorbane trioleate, polyoxyethylene monostearate, or a combination thereof. The polyoxyethylene sorbitan fatty acid ester may be commercially available in the trade name of, for example, Triton X-100 (component name: Octylphenyl polyethylene glycol).

The polyoxyethylene fatty acid ester may be commercially available in trade names including Brij30, Brij35, Brij52, Brij56, Brij58, Brij72, Brij76, Brij78, Brij92V, Brij93, Brij96V, Brij97, Brij98, Brij700, etc. Components and HLB values of these materials are summarized in Table 1.

TABLE 1

| | Compound | HLB value |
|---|---|---|
| Brij®30 | Polyoxyethylene (4) lauryl ether | 9.7 |
| Brij®35 | Polyoxyethylene (23) lauryl ether | 16.9 |
| Brij®52 | Polyoxyethylene (2) cetyl ether | 5.3 |
| Brij®56 | Polyoxyethylene (10) cetyl ether | 12.9 |
| Brij®58 | Polyoxyethylene (20) cetyl ether | 15.7 |
| Brij®72 | Polyoxyethylene (2) stearyl ether | 4.9 |
| Brij®76 | Polyoxyethylene (10) stearyl ether | 12.4 |
| Brij®78 | Polyoxyethylene (20) stearyl ether | 15.3 |
| Brij®92V | Polyoxyethylene (2) oleyl ether | 4.9 |
| Brij®93 | Polyoxyethylene (2) oleyl ether | 4 |
| Brij®96V | Polyoxyethylene glycol oleyl ether | 12.4 |
| Brij®97 | Polyoxyethylene (10) oleyl ether | 12 |
| Brij®98 | Polyoxyethylene (20) oleyl ether | 15.3 |
| Brij®700 | Polyoxyethylene (100) stearyl ether | 18 |

The organic compound according to an embodiment, which is non-reactive with lithium and is a non-ionic material having a hydrophobic region and a hydrophilic region, may be, for example, polyethylene glycol sorbitan monolaurate, polyoxyethylene sorbitan monopalmitate, polyoxyethylene sorbitan monostearate, or a combination thereof. Such compounds may be purchased in the market in product names of Tween 20, Tween®40, Tween®60, Tween®65, 80, Tween®95, etc. Components and HLB values of these materials are summarized in Table 2.

TABLE 2

| | [symbol] | HLB [symbol] |
|---|---|---|
| Tween® 20 | Polyoxyethylene (20) sorbitan monolaurate | 16.0 |
| Tween® 40 | Polyoxyethylene (20) sorbitan monopalmitate | 15.6 |
| Tween® 60 | Polyoxyethylene sorbitan monostearate | 14.9 |
| Tween® 65 | Polyoxyethylene sorbitan tristearate | 10.5 |
| Tween® 80 | Polyoxyethylene (20) sorbitan monooleate | 15.0 |
| Tween® 85 | Polyoxyethylene sorbane trioleate | 11.0 |

An amount of the organic compound not reacting with lithium while being a non-ionic material having a hydrophobic region and a hydrophilic region, is 0.5 parts by weight to 10 parts by weight, 0.8 parts by weight to 8 parts by weight, or 1 parts by weight to 5 parts by weight, on the basis of 100 parts by weight of total amounts of the raw materials for forming the sulfide solid electrolyte containing lithium. As used herein, the phrase “total amounts of raw materials for forming a sulfide solid electrolyte” refer to total amounts of precursors for forming a sulfide solid electrolyte. When an amount of the organic compound is within the above range, it is easy to obtain a sulfide solid electrolyte having controlled particle distribution and particle size.

In preparing the sulfide solid electrolyte, when an ionic and/or lithium-reactive organic compound, is used, instead of the organic compound which is non-reactive with lithium and is a non-ionic material having a hydrophobic region and a hydrophilic region, impurities may be generated due to side reactions with Li ions present in the sulfide solid electrolyte, resulting in irreversibility.

The raw materials for forming the sulfide solid electrolyte according to an embodiment may include a sulfur (S) precursor, a phosphorus (P) precursor, and a halogen X precursor, and X in the halogen X precursor may be chlorine (Cl), bromine (Br), fluorine (F), iodine (I), a pseudohalogen, or a combination thereof.

An M precursor may be further added to the precursor mixture. M in the M precursor may be sodium (Na), potassium (K), calcium (Ca), iron (Fe), magnesium (Mg), silver (Ag), zirconium (Zr), zinc (Zn), or a combination thereof.

The heat treatment for obtaining a sulfide solid electrolyte is performed at a temperature of 300° C. to 600° C. The heat treatment may be performed at a temperature in a range of 300° C. to 550° C., for example, in a range of 350° C. to 500° C. When the heat treatment is performed at a temperature in the above range, a sulfide solid electrolyte having an argyrodite crystal structure showing an excellent particle size distribution and a relatively small particle size may be obtained.

The providing of the precursor mixture may include: obtaining a first mixture by mixing a sulfur precursor and a phosphorus precursor with a first solvent; obtaining a second mixture by mixing a sulfur precursor and a halogen X precursor with a second solvent; and mixing the first mixture with the second mixture.

The first solvent and the second solvent may be the same or different. The first solvent is a solvent for dissolving or dispersing the sulfur precursor and the phosphorus precursor, and examples thereof may include one or more selected from the group consisting of tetrahydrofuran, acetonitrile, butylacetate, N-ethylacetate, N-methylformamide, heptane, and xylene. In addition, the second solvent is a solvent for dissolving or dispersing lithium, the sulfur precursor and the halogen X precursor, and may include one or more organic solvents selected from a hydroxyl group, such as ethanol, methanol or propanol, acetonitrile, ethylpropionate, heptane, xylene, and linear and cyclic hydrocarbons (for example, propane, heptane, or pentane or a combination thereof).

As described above, if the precursor mixture is obtained through the steps of obtaining of the first mixture by mixing the sulfur precursor and the phosphorus precursor with the first solvent, obtaining the second mixture by mixing the sulfur precursor and the halogen X precursor with the second solvent, and mixing the first mixture and the second mixture, the ionic conductivity of the sulfide solid electrolyte can be prevented from being lowered due to a side reaction between a precursor, e.g., P₂S₅, and a solvent, e.g., ethanol.

According to an embodiment, the sulfur precursor and the phosphorus precursor reacting with the first solvent are Li₂S and P₂S₅, respectively, and the sulfur precursor and the X precursor reacting with the second solvent are, for example, Li₂S and LiCl, respectively. Li₃PS₄ is first prepared using Li₂S and P₂S₅ in the first solvent, such as THF, and Li₂S and LiCl are then reacted in ethanol, thereby obtaining the precursor mixture.

One or more selected from the sulfur precursor, the phosphorus precursor, and the X precursor may contain lithium.

The sulfur precursor may be, for example, Li₂S, etc., the phosphorus precursor may be, for example, P₂S₅, red phosphorus, white phosphorus, phosphorus powder, P₂O₅, (NH₄)₂HPO₄, (NH4)H2PO4, Na₂HPO₄, Na₃PO₄, etc.

The halogen X precursor may be, for example, a lithium halide. The lithium halide may be, for example, LiCl, Lil, LiBr, or a combination thereof.

An M precursor may be further added to the precursor mixture. M in the M precursor may be sodium (Na), potassium (K), calcium (Ca), iron (Fe), magnesium (Mg), silver (Ag), zirconium (Zr), zinc (Zn), or a combination thereof.

The sulfide solid electrolyte may be prepared by obtaining a sulfide solid electrolyte precursor through the reactions of the precursor mixture and performing heat treatment on the obtained sulfide solid electrolyte precursor.

A temperature of the heat treatment may be in a range of, for example, 300° C. to 600° C., preferably 300° C. to 550° C., or 350° C. to 500° C. When the heat treatment is performed in the above-described temperature range, the sulfide solid electrolyte having an argyrodite crystal structure can be easily obtained. A time duration for the heat treatment may vary according to the temperature of the heat treatment, and may be, for example, 1 to 100 hours, 10 to 80 hours, 20 to 28 hours, or 24 hours. When the heat treatment time is within the above range, the obtained solid electrolyte may exhibit a high ionic conductivity while having high-temperature stability.

An atmosphere of the heat treatment is an inert atmosphere. The heat treatment atmosphere may be created using, for example, but not limited to, nitrogen or argon gas, and any gas that is used in the inert atmosphere in the related art may be used.

The sulfide solid electrolyte according to an embodiment may have a thickness in a range of 10 µm to 200 µm. When the thickness of the sulfide solid electrolyte is within the above range, an all-solid secondary battery prepared using the same exhibits significantly improved cycle life characteristics.

The all-solid secondary battery may be manufactured, for example, by preparing a sulfide solid electrolyte by the above-described method, forming a cathode layer 10, an anode layer 20 and/or a solid electrolyte layer 30, respectively, using the prepared sulfide solid electrolyte, and then stacking the formed layers.

By the method according to the embodiment, provided is a solid electrolyte comprising a compound represented by Formula 1 below and having an argyrodite crystal structure, wherein the compound of Formula 1 has a D50 of 0.9 µm to 5.0 µm, a D10 of 0.1 µm to 0.+8 µm, and a D90 of 3 µm to 20 µm:

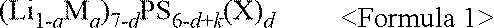

wherein, in Formula 1, M is sodium (Na), potassium (K), calcium (Ca), iron (Fe), magnesium (Mg), silver (Ag), zirconium (Zr), zinc (Zn), or a combination thereof, X is chlorine (Cl), bromine (Br), fluorine (F), iodine (I), a pseudohalogen, or a combination thereof, 0<x<1, 0≤a<1, 0<d≤1.8, and O≤k<1.

By the method according to one or more embodiments, provided is a solid ion conductor comprising a compound represented by Formula 1 below and having an argyrodite crystal structure, wherein the compound of Formula 1 has a D50 of 0.9 µm to 5.0 µm, a D10 of 0.1 µm to 0.8 µm, and a D90 of 3 µm to 20 µm. The solid ion conductor is used for batteries, supercapacitors, accumulators and electrochromic devices, chemical sensors or thermoelectric converters. In the present specification, D10, D50 and D90 respectively indicate particle diameters corresponding to 10%, 50% and 90%, by volume, when particles are cumulatively distributed in order from a smallest size.

In the present specification, when the particles have a spherical shape, the particle size may mean an average diameter, and when the particles have a non-spherical shape, the particle size may mean a long-axis length. The particle size may be identified using a scanning electron microscope, a particle size analyzer, or a laser type particle size distribution meter. For example, the particle size may be a median diameter (D50) measured by a layer type particle size distribution meter.

The compound of Formula 1 has a D50 in a range of, for example, 1.0 µm to 4.0 µm or 1.2 µm to 3.8 µm, a D10 in a range of, for example, 0.1 µm to 0.7 µm or 0.3 µm to 0.65 µm, and a D90 in a range of, for example, 4 µm to 12 µm or 5 µm to 11 µm, respectively.

D90-D10 may be 20 or less, 15 or less, 10 or less, or in a range of 1 to 10, 5 to 10, 5 to 9, or 5.04 to 5.63.

A relative span factor (R.S.F) of the particle size distribution is calculated using Equation 1:

$$\text{R} \text{.S} \text{.F=} \left(\text{D90-D10}\right) / \text{D50} \qquad \text{<Equation 1>}$$

The relative span factor (R.S.F) of the compound of Formula 1 is 2.6 to 10, 2.65 to 8, 2.7 to 5, or 2.75 to 4. When the particle size distribution is within the above range, a sulfide solid electrolyte having a uniform particle size can be obtained.

In Formula 1, when M is a monovalent element, such as sodium (Na), potassium (K), or silver (Ag), k=0, and when M is a divalent or trivalent element, such as calcium (Ca), iron (Fe), magnesium, (Mg), silver (Ag), zirconium (Zr), or zinc (Zn), 0<k<1.

In the present specification, the term “pseudohalogen” refers to a molecule consisting of more than two electronegative atoms which, in a free state, resemble halogens, and the pseudohalogen generates anions which resemble halide ions. Examples of the pseudohalogen may include cyanide (CN), cyanate (OCN), thiocyanate (SCN), azide (N₃), or a combination thereof.

In Formula 1, 0<x≤0.5.

According to an embodiment, in Formula 1, 0<d≤1.

In Formula 1, (X)_{d} is (Cl)_{d}, (Br)_{d}, or (Br₁₋ₓ₂(Cl)ₓ₂)_{d}, where 0<x2<1 and 0<d≤1.

The argyrodite type solid electrolyte according to an embodiment may be, for example, a compound represented by Formula 2 below:

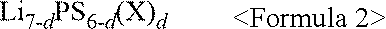

wherein, in Formula 2, X is chlorine (Cl), bromine (Br), iodine (I), or a combination thereof, and 0<d≤1.

In Formula 2, (X)_{d} is (Cl)_{d}, (Br)_{d}, or (Br₁₋ₓ₁(Cl)ₓ₁)_{d}, where 0<x1<1 and 0<d≤1, and x1 may be in a range of 0.1 to 0.9, for example, 0.2 to 0.8, 0.3 to 0.7, 0.4 to 0.6, or 0.5.

The compound represented by Formula 1 may be, for example, a compound represented by Formula 3 or Formula 4 below:

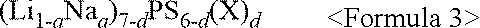

wherein, in Formula 3, X is chlorine (Cl), bromine (Br), fluorine (F), iodine (I), a pseudohalogen, or a combination thereof, 0<a<1, and 0<d≤1, and

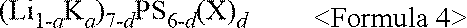

wherein, in Formula 4, X is chlorine (Cl), bromine (Br), fluorine (F), iodine (I), a pseudohalogen, or a combination thereof, 0<x<1, 0<d≤1, and 0<a<1.

The compound represented by Formula 1 may be, for example, a compound represented by Formula 5 below:

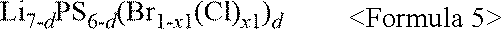

wherein, in Formula 5, 0<d≤1, 0<a<1, and 0<x1<1.

The compound of Formula 1 may include, for example, Li₆PS₅Cl, Li_{5.8}PS_{4.8}Cl_{1.2}, Li₆PS₅Br, or Li_{5.8}PS_{4.8}ClBr₀.₂.

In Raman spectroscopy analysis for the compound of Formula 1 in the sulfide solid electrolyte according to an embodiment, a peak A appearing at a wavenumber of 380 cm⁻¹ to 480 cm⁻¹, a peak B appearing at a wavenumber of 130 cm-¹ to 220 cm⁻¹, a peak C appearing at a wavenumber of 220 cm⁻¹ to 320 cm⁻¹ and a peak D appearing at a wavenumber of 520 cm⁻¹ to 620 cm⁻¹, are all peaks exhibiting an argyrodite crystalline structure. In particular, P₂S₆⁴⁻ and P₂S₇⁴⁻, as a material having low ionic conductivity, may appear together in the peak A due to a P-S bond. The peak A is associated with a PS₄ structure exhibiting high ionic conductivity. If any other materials are further present, the peak A may become broader.

A full width at half maximum (FWHM) of the peak A appearing at a wavenumber of 380 cm⁻¹ to 480 cm-¹ is 10 cm-¹ to 20 cm-¹ or 14 cm-¹ to 16.5 cm⁻¹.

In Raman spectroscopy analysis for the compound of Formula 1 in the sulfide solid electrolyte according to an embodiment, it is confirmed that the sulfide solid electrolyte has a higher ionic conductivity as the peak A has a higher intensity,.

The peak A has a central wavenumber of about 422 cm⁻¹, the peak B has a central wavenumber of about 197 cm⁻¹, the peak D has a central wavenumber of about 265 cm⁻ ¹, and the peak E has a central wavenumber of about 572 cm⁻¹. As used herein, the term “central wavenumber” means a wavenumber at which each peak shows the maximum intensity.

In Raman spectroscopy analysis, an intensity ratio (I_{A/}I_{B}) of the peak A and the peak B is 8 or greater, 8 to 15, 8.1 to 13, or 8.2 to 11.

In Raman spectroscopy analysis for the compound, an intensity ratio (I_{A}/I_{c}) of the peak A appearing at wavenumber of 380 cm-¹ to 480 cm-¹ and the peak C appearing at wavenumber of 220 cm⁻¹ to 320 cm⁻¹, is 8 or greater, 8 to 10, 8.1 to 9.8, for example, 8.3 to 9.5.

The intensity ratio (I_{A}/I_{B}) of the peak A appearing at wavenumber of 380 cm-¹ to 480 cm-¹ and the peak B appearing at wavenumber of 130 cm⁻¹ to 220 cm⁻¹, is 8 or greater, 8 to 15, 8.1 to 13, or 8.2 to 11. In addition, the full width at half maximum of the peak A appearing at wavenumber of 380 cm⁻¹ to 480 cm⁻¹ is 10 cm⁻¹ to 20 cm⁻¹ or 14 cm⁻¹ to 16.5 cm⁻¹. When the full width at half maximum of the peak A is within the above range, a sulfide solid electrolyte having a high ionic conductivity can be obtained.

In Raman spectroscopy analysis for the compound, an intensity ratio (I_{A}/I_{c}) of the peak A appearing at wavenumber of 380 cm-¹ to 480 cm-¹ and the peak C appearing at wavenumber of 220 cm⁻¹ to 320 cm⁻¹, is 8 or greater, 8 to 10, or 8.1 to 9.8, for example, 8.3 to 9.5. In addition, in Raman spectroscopy analysis for the compound, an intensity ratio (I_{A}/I_{D}) of the peak A appearing at wavenumber of 380 cm-¹ to 480 cm-¹ and the peak D appearing at wavenumber of 520 cm-¹ to 620 cm⁻¹, is 8 or greater, 8 to 10, 8.1 to 9, or 8.2 to 8.8.

The sulfide solid electrolyte according to an embodiment may be used as a material of an electrolyte for an all-solid battery and/or an electrolyte for a cathode layer. In addition, the solid electrolyte may also be used as a cathode layer and/or an electrolyte for a lithium-sulfur battery.

The sulfide solid electrolyte according to an embodiment may be used as a cathode electrolyte in forming a cathode, and may also be used as a protection film of an anode layer for a lithium metal battery.

The sulfide solid electrolyte according to an embodiment has an ionic conductivity of 1 mS/cm or greater, 1.3 mS/cm or greater, 1.5 mS/cm or greater, 1.6 mS/cm or greater, 2.0 mS/cm or greater, 2.0 mS/cm to 20 mS/cm or 2.0 mS/cm to 10 mS/cm, as measured at 25° C. The sulfide solid electrolyte may be applied to an electrolyte of an electrochemical cell by having a high ionic conductivity of 1 mS/cm or greater.

An electrochemical cell according to one or more embodiments includes: a cathode layer; an anode layer; a solid electrolyte layer positioned between the cathode layer and the anode layer, and at least one selected from the cathode layer, the anode layer, and the solid electrolyte layer includes the above-described solid electrolyte. For example, the cathode layer and/or, the solid electrolyte layer includes the above-described solid electrolyte Since a side reaction between the solid electrolyte layer and a lithium metal included in the anode layer is suppressed by including the sulfide solid electrolyte according to an embodiment, the electrochemical cell has improved cycle characteristics.

For example, the electrochemical cell may include, but not limited to, an all-solid secondary battery or a lithium air battery, and any electrochemical cell that is useful in the related art may be used.

In the electrochemical cell according to an embodiment, the cathode layer includes a solid electrolyte including a compound represented by Formula 1 below and having an argyrodite crystal structure:

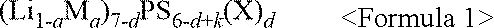

wherein, in Formula 1, M is sodium (Na), potassium (K), calcium (Ca), iron (Fe), magnesium (Mg), silver (Ag), zirconium (Zr), zinc (Zn), or a combination thereof, X is chlorine (Cl), bromine (Br), fluorine (F), iodine (I), a pseudohalogen, or a combination thereof,

$$0 \leq a < 1 , 0 < d \leq 1.8 , \text{and} 0 \leq k < 1.$$

In the cathode layer, an amount of the sulfide solid electrolyte of Formula 1 is 2 parts by weight to 70 parts by weight, for example, 3 parts by weight to 70 parts by weight, 3 parts by weight to 60 parts by weight, or 10 parts by weight to 60 parts by weight, on the basis of 100 parts by weight of the cathode active material. When an amount of the sulfide solid electrolyte in the cathode layer is within the above range, the electrochemical cell may have improved high-voltage stability.

The electrochemical cell according to an embodiment has a capacity retention ratio of 85% or higher, for example, 86% or higher, 88% or higher, or 88% to 99.5%, at the 100th cycle after performing charging and discharging in a thermostat of 25° C. at a voltage of 4 V or higher.

In the all-solid secondary battery, the solid electrolyte used in an active material layer has a particle diameter range different from that of the solid electrolyte used in a solid electrolyte layer. The solid electrolyte used in an active material layer has a smaller average particle diameter than the solid electrolyte used in, for example, a solid electrolyte layer. The average particle diameter of the solid electrolyte used in the active material layer is in a range of 100 nm to 10 µm, 300 nm to 8 µm, or 500 nm to 5 µm, and the average particle diameter of the solid electrolyte used in the solid electrolyte layer is in a range of 500 nm to 20 µm, 700 nm to 15 µm, or 900 nm to 10 µm.

Hereinafter, an electrochemical cell according to an embodiment will be described in greater detail with regard to an all-solid secondary battery by way of example.

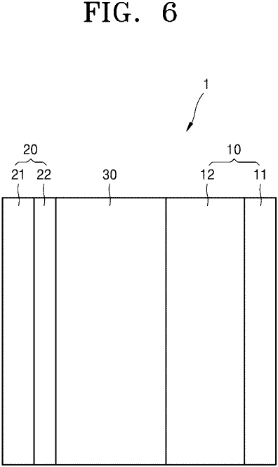

Referring to FIGS. 6 to 8, the all-solid secondary battery 1 includes an anode layer 20 including an anode current collector layer 21 and a first anode active material layer 22, a cathode layer 10 including a cathode active material layer 12, and a solid electrolyte layer 30 positioned between the anode layer 20 and the cathode layer 10. The cathode layer 10 may include a sulfide solid electrolyte according to an embodiment. The cathode layer 10 may include, for example, a cathode active material, a solid electrolyte and a conductive agent.

### Anode Layer

Referring to FIGS. 6 to 8, the anode layer 20 includes an anode current collector layer 21 and a first anode active material layer 22, and the first anode active material layer 22 includes an anode active material.

The anode active material included in the first anode active material layer 22 may have, for example, a particle shape. An average particle diameter of the anode active material having a particle shape may be, for example, 4 µm or less, 3 µm or less, 2 µm or less, 1 µm or less, or 900 nm or less. The average particle diameter of the anode active material having a particle shape may be in a range of, for example, 10 nm to 4 µm, 10 nm to 3 µm, 10 nm to 2 µm, 10 nm to 1 µm, or 10 nm to 900 nm. When the anode material has an average particle diameter within these ranges, reversible absorption and/or desorption of lithium during charge and discharge may be further facilitated. The average particle diameter of the anode active material may be a median diameter (D50), as measured by, for example, a laser type particle size distribution meter.

The anode active material included in the first anode active material layer 22 includes, for example, one or more selected from a carbon-based anode active material and a metal or metalloid anode active material.

Specifically, the carbon-based anode active material may be amorphous carbon. For example, the amorphous carbon may include, but not limited to, carbon black (CB), acetylene black (AB), furnace black (FB), ketjen black (KB), graphene, or a combination thereof, and any amorphous carbon that is classified as amorphous carbon in the related art may be used. The amorphous carbon refers to carbon without crystallinity or with extremely low crystallinity, and is distinguished from crystalline carbon or graphitic carbon.

The metal or metalloid anode active material may include, but not limited to, one or more selected from the group consisting of gold (Au), platinum (Pt), palladium (Pd), silicon (Si), silver (Ag), aluminum (Al), bismuth (Bi), tin (Sn), and zinc (Zn), and any metal anode active material or metalloid anode active material capable of forming an alloy or compound with lithium may be used. For example, nickel (Ni), which does not form an alloy with lithium, may not be a metal anode active material.

The first anode active material layer 22 may include one of the foregoing anode active materials or may include a mixture of two or more different anode active materials of the foregoing anode active materials. For example, the first anode active material layer 22 may include only amorphous carbon alone, or may include one or more selected from the group consisting of gold (Au), platinum (Pt), palladium (Pd), silicon (Si), silver (Ag), aluminum (Al), bismuth (Bi), tin (Sn) and zinc (Zn). In another embodiment, the first anode active material layer 22 may include mixtures of amorphous carbon and one or more selected from the group consisting of gold (Au), platinum (Pt), palladium (Pd), silicon (Si), silver (Ag), aluminum (Al), bismuth (Bi), tin (Sn) and zinc (Zn). A mixed ratio of the amorphous carbon to gold (Au) may be, for example, but not limited to, 10:1 to 1:2, 5:1 to 1:1, or 4:1 to 2:1, by weight, and may be appropriately chosen according to desired characteristics of the all-solid secondary battery 1. By having such a composition as described above, the anode active material may further improve the cycle characteristics of the all-solid secondary battery 1.

The anode active material included in the first anode active material layer 22 may include, for example, a mixture of first particles consisting of amorphous carbon and second particles consisting of a metal or metalloid. Examples of the metal or metalloid may be gold (Au), platinum (Pt), palladium (Pd), silicon (Si), silver (Ag), aluminum (Al), bismuth (Bi), tin (Sn), and zinc (Zn). As another example, the metalloid may be a semiconductor. The amount of the second particles may be 8 wt% to 60 wt%, 10 wt% to 50 wt%, 15 wt% to 40 wt%, or 20 wt% to 30 wt%, on the basis of a total weight of the mixture. By having the amount within the above ranges, the second particles may further improve the cycle characteristics of the all-solid secondary battery 1.

The first anode active material layer 22 may include, for example, a binder. Examples of the binder may include, but not limited to, styrene butadiene rubber (SBR), polytetrafluoroethylene (PTFE), polyvinylidene fluoride (PVDF), polyethylene, a polyvinylidene fluoride/hexafluoropropylene copolymer, a hexafluoropropylene copolymer, polyacrylonitrile, or polymethylmethacrylate, and any suitable binder that is useful as a binder in the related art may be used. The binder may consist of a single binder or a plurality of different binders.

By inclusion of the binder, the first anode active material layer 22 may be stabilized on the anode current collector 21. In addition, in spite of a volume change and/or a relative position change of the first anode active material layer 22 during charging and discharging, cracking of the first anode active material layer 22 may be suppressed. For example, when a binder is not included in the first anode active material layer 22, the first anode active material layer 22 may be easily separated from the anode current collector 21. A portion of the first anode active material layer 22, separated from the anode current collector 21 may partially expose the anode current collector 21 to then be brought into contact with the solid electrolyte layer 30, and thus a probability of occurrence of short-circuits may increase. For example, the first anode active material layer 22 may be formed by coating, on the anode current collector 21, a slurry in which ingredients of the first anode active material layer 22 are dispersed, and then drying the resulting product. By inclusion of the binder in the first anode active material layer 22, the anode active material may be stably dispersed in the slurry. When the slurry is coated on the anode current collector 21, for example, by screen printing, clogging of the screen (for example, clogging by aggregates of the anode active material) may be suppressed.

A thickness d22 of the first anode active material layer 22 may be, for example, 50% or less, 40% or less, 30% or less, 20% or less, 10% or less, or 5% or less, of a thickness d12 of the cathode active material layer 12. The thickness d22 of the first anode active material layer 22 may be, for example, 1 µm to 20 µm, 2 µm to 10 µm, or 3 µm to 7 µm. When the thickness d22 of the first anode active material layer 22 is too small, the first anode active material layer 22 may be disintegrated by lithium dendrites generated between the first anode active material layer 22 and the anode current collector 21, consequently making it difficult to improve cycle characteristics of the all-solid secondary battery 1. When the thickness d22 of the first anode active material layer 22 is excessively increased, the all-solid secondary battery 1 may have a reduced energy density and an increased internal resistance, and thus it is difficult to improve the cycle characteristics of the all-solid secondary battery 1.

When the thickness d22 of the first anode active material layer 22 is reduced, for example, the first anode active material layer 22 may have a reduced charge capacity accordingly. For example, a charge capacity of the first anode active material layer 22 may be 50% or less, 40% or less 30% or less, 20% or less, 10% or less, 5% or less, or 2% or less of a charge capacity of the cathode active material layer 12. A charge capacity of the first anode active material layer 22 may be, for example, 0.1% to 50%, 0.1% to 40%, 0.1% to 30%, 0.1% to 20%, 0.1% to 10%, 0.1% to 5%, or 0.1% to 2% of a charge capacity of the cathode active material layer 12. When the charge capacity of the first anode active material layer 22 is too small, the thickness of the first anode active material layer 22 may be excessively reduced, so that the first anode active material layer 22 is disintegrated by lithium dendrites generated between the first anode active material layer 22 and the anode current collector 21 during repeated charging and discharging processes, consequently making it difficult to improve cycle characteristics of the all-solid secondary battery 1. When the charge capacity of the first anode active material layer 22 is excessively increased, the all-solid secondary battery 1 may have a reduced energy density and an increased internal resistance, and thus it is difficult to improve the cycle characteristics of the all-solid secondary battery 1.

The charge capacity of the cathode active material layer 12 may be obtained by multiplying a charge capacity density (milliampere hours per gram, mAh/g) of a cathode active material in the cathode active material layer 12 by a mass of the cathode active material. When different kinds of cathode active materials are used, a charge capacity density of each of the cathode active materials may be multiplied by a mass thereof, and then the sum of the multiplication products may be calculated as the charge capacity of the cathode active material layer 12. The charge capacity of the first anode active material layer 22 may be calculated in the same manner. That is, the charge capacity of the first anode active material layer 22 may be obtained by multiplying a charge capacity density (mAh/g) of an anode active material in the first anode active material layer 22 by a mass of the anode active material. When different kinds of anode active materials are used, a charge capacity density of each of the anode active materials may be multiplied by a mass thereof, and then the sum of the multiplication products may be calculated as the charge capacity of the first anode active material layer 22. The charge capacity densities of the cathode active material and the anode active material are estimated capacities obtained with an all-solid half-cell including lithium metal as a counter electrode. The charge capacities of the cathode active material layer 12 and the first anode active material layer 22 may be directly calculated using an all-solid half-cell. The measured charge capacity of each of the positive and negative the cathode active materials may be divided by a mass of the corresponding active material to thereby obtain the charge capacity density of the active material. In another embodiment, the charge capacities of the cathode active material layer 12 and the first anode active material layer 22 may be initial charge capacities measured after 1st cycle charging.

The anode current collector 21 may consist of, for example, a material which does not react with lithium, that is, a material which does not form an alloy or compound. Examples of the material of the anode current collector 21 may include, but not limited to, copper (Cu), stainless steel, titanium (Ti), iron (Fe), cobalt (Co), and nickel (Ni), and any material available in the art as an anode current collector may be used. The anode current collector 21 may include one of the foregoing metals, or an alloy or coating material of two or more of the foregoing metals. The anode current collector 21 may be, for example, in the form of a plate or a foil.

The first anode active material layer 22 may further include one or more additives such as a filler, a dispersant, or an ionic conductive agent.

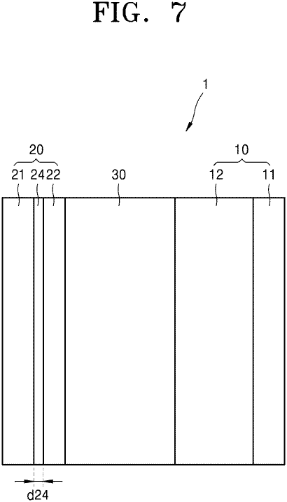

Referring to FIG. 7, the all-solid secondary battery 1 may further include, for example, a thin film 24 including an element that is alloyable with lithium, on the anode current collector 21. The thin film 24 is positioned between the anode current collector 21 and the first anode active material layer 22. The thin film 24 may include, for example, an element that is alloyable with lithium. Examples of the element that is alloyable with lithium may include, but not limited to, gold, silver, zinc, tin, indium, silicon, aluminum, and bismuth, and any suitable element that is that is alloyable with lithium may be used. The thin film 24 may consist of one or an alloy of different metals of the foregoing metals. By positioning the thin film 24 on the anode current collector 21, a second anode active layer (not shown) precipitated between the thin film 24 and the first anode active material layer 22, for example, may be further planarized, and thus the all-solid secondary battery 1 may have further improved cycle characteristics.

A thickness d24 of the thin film 24 may be, for example, 1 nm to 800 nm, 10 nm to 700 nm, 50 nm to 600 nm, or 100 nm to 500 nm. When the thickness d24 of the thin film 24 is less than 1 nm, a predetermined function of the thin film 24 may not be properly exhibited. When the thin film 24 is excessively thick, lithium may be absorbed by the thin film 24 itself, resulting in a reduction in the amount of lithium precipitated on the anode layer, thereby consequently lowering the energy density of the all-solid secondary battery 1 and deteriorating the cycle characteristics thereof. The thin film 24 may be formed on the anode current collector 21 by using, for example, but not limited to, a vapor deposition method, a sputtering method, or a plating method, and any suitable method that is useful to form the thin film 24 in the art may be used.

According to an embodiment, the all-solid secondary battery 1 may further include a second anode active material layer 23 positioned, for example, between the anode current collector 21 and the solid electrolyte layer 30 through charging.

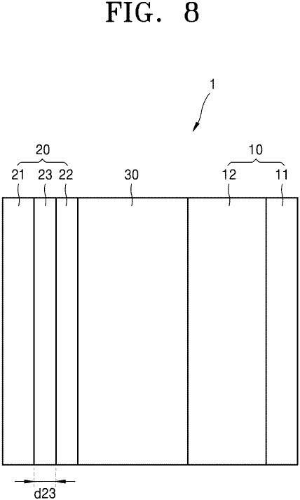

As shown in FIG. 8, the all-solid secondary battery 1 may further include a second anode active material layer 23 positioned, for example, between the anode current collector 21 and the first anode active material layer 22 through charging. Although not shown, the all-solid secondary battery 1 may further include a second anode active material layer 23 positioned, for example, between the solid electrolyte layer 30 and the first anode active material layer 22 through charging. Although not shown, the all-solid secondary battery 1 may further include a second anode active material layer 23 located, for example, within the first anode active material layer 22 through charging.

The second anode active material layer 23 which is a metal layer including lithium or a lithium alloy. The metal layer includes lithium or a lithium alloy. Therefore, the second anode active material layer 23, which is a metal layer including lithium, may function, for example, as a lithium reservoir. Examples of the lithium alloy may include, but not limited to, a Li—Al alloy, a Li—Sn alloy, a Li-In alloy, a Li—Ag alloy, a Li—Au alloy, a Li—Zn alloy, a Li—Ge alloy, a Li—Si alloy, or a combination thereof, and any lithium alloy that is useful as a lithium alloy may be used. The second anode active material layer 23 may include lithium, one or a plurality of different alloys, among such lithium alloys.

A thickness d23 of the second anode active material layer may be, for example, but not particularly limited to, 1 µm to 1000 µm, 1 µm to 500 µm, 1 µm to 200 µm, 1 µm to 150 µm, 1 µm to 100 µm, or 1 µm to 50 µm. When the thickness d23 of the second anode active material layer 23 is too small, the second anode active material layer 23 may not properly function as a lithium reservoir. When the thickness d23 of the second anode active material layer 23 is excessively thick, the mass and volume of the all-solid secondary battery 1 may be increased and cycle characteristics thereof may be deteriorated. The second anode active material layer 23 may be, for example, a metal foil having a thickness within these ranges.

In the all-solid secondary battery 1, the second anode active material layer 23 may be positioned, for example, between the anode current collector 21 and the first anode active material layer 22 prior to assembling of the all-solid secondary battery 1, or may be precipitated between the anode current collector 21 and the first anode active material layer 22 through charging, after assembling of the all-solid secondary battery 1.

When the second anode active material layer 23 is positioned between the anode current collector 21 and the first anode active material layer 22 prior to assembling of the all-solid secondary battery 1, the second anode active material layer 23, as a metal layer including lithium, may function as a lithium reservoir. The all-solid secondary battery 1 including the second anode active material layer 23 may have further improved cycle characteristics. For example, before assembling the all-solid secondary battery 1, a lithium foil is positioned between the anode current collector 21 and the first anode active material layer 22.

When the second anode active material layer 23 is positioned through charging after assembling the all-solid secondary battery 1, the all-solid secondary battery 1 may have an increased energy density because the second anode active material layer 23 is not included during the assembling of the solid secondary battery 1. For example, during charging, the all-solid secondary battery 1 may be charged in excess of a charge capacity of the first anode active material layer 22. That is, the first anode active material layer 22 may be overcharged. At an initial charging stage, lithium may be absorbed into the first anode active material layer 22. That is, the anode active material included in the first anode active material layer 22 may form an alloy or compound with lithium ions which have moved from the cathode layer 10. When the all-solid secondary batter 1 is charged over the capacity of the first anode active material layer 22, for example, lithium may be precipitated on a rear surface of the first anode active material layer 22, i.e., between the anode current collector 21 and the first anode active material layer 22, thus forming a metal layer corresponding to the second anode active material layer 23 by the precipitated lithium. The second anode active material layer 23 is a metal layer including lithium (i.e., metal lithium) as a major component. Such results may be attributed to, for example, the fact that the anode active material included in the first anode active material layer 22 includes a material capable of forming an alloy or compound with lithium. During discharging, lithium in the first anode active material layer 22 and the second anode active material layer 23, i.e., lithium of the metal layer, may be ionized and then move towards the cathode layer 10. Therefore, the all-solid secondary battery 1 may use lithium as the anode active material. In addition, the first anode active material layer 22 coats the second anode active material layer 23, and thus may function as a protective layer of the second anode active material layer 23 and at the same time suppress precipitation and growth of lithium dendrites. Therefore, a short-circuit and a reduction in the capacity of the all-solid secondary battery 1 may be suppressed, and consequently cycle characteristics of the all-solid secondary battery 1 may be improved. In addition, when the second anode active material layer 23 is positioned through charging after assembling the all-solid secondary battery 1, the anode current collector 21, the first anode active material layer 22, and a region therebetween may be, for example, Li-free regions which do not include lithium (Li) metal or a Li alloy in an initial state or a post-discharge state of the all-solid secondary battery.

The all-solid secondary battery 1 may be configured such that the second anode active material layer 23 is positioned on the anode current collector 21, as shown in FIG. 8, or the solid electrolyte layer 30 is directly located on the second anode active material layer 23. The second anode active material layer 23 may be, for example, a lithium metal layer or a lithium alloy layer.

By inclusion of the sulfide solid electrolyte in the solid electrolyte layer 30, a side reaction between the solid electrolyte layer 30 and the second anode active material layer 23 as a lithium metal layer is suppressed, and thus cycle characteristics of the all-solid secondary battery 1 may be improved.

### Solid Electrolyte Layer

Referring to FIGS. 6 to 8, the solid electrolyte layer 30 includes a solid electrolyte positioned between the cathode layer 10 and the anode layer 20, and the solid electrolyte includes a sulfide solid electrolyte according to an embodiment.

The solid electrolyte may further include a common sulfide-based solid electrolyte used in the related art, in addition to the sulfide-based solid electrolyte according to one or more embodiments. Examples of the solid electrolyte may include one or more selected from Li₂S—P₂S₅, Li₂S—P₂S_{S}—LiX, where X is a halogen element, Li₂S—P₂S₅—Li₂O, Li₂S—P₂S₅—Li₂O—Lil, Li₂S—SiS₂, Li₂S—SiS₂—Lil, Li₂S—SiS₂—LiBr, Li₂S—SiS₂—LiCl, Li₂S—SiS₂—B₂S₃—Lil, Li₂S—SiS₂—P₂S₅—Lil, Li₂S—B₂S₃, Li₂S—P₂S₅—ZₘSₙ, where m and n are each a positive number, Z is one selected from Ge, Zn and Ga, Li₂S—GeS₂, Li₂S—SiS₂—Li₃PO₄, and Li₂S—SiS₂—LiₚMO_{q}, where p and q are each a positive number, M is one selected from the group consisting of P, Si, Ge, B, Al, Ga and In. The sulfide solid electrolyte further included in the solid electrolyte may be amorphous or crystalline, or in a mixed phase.

In addition, among the above-stated materials of the sulfide based solid electrolyte, a material containing one or more constituent elements selected from the group consisting of sulfur (S), phosphorus (P) and lithium (Li). For example, the sulfide solid electrolyte may be a material including Li₂S—P₂S₅. When the material including Li₂S-P₂S₅is used as the sulfide solid electrolyte material, a mixing molar ratio of Li₂S and P₂S₅, that is, Li₂S—P₂S₅ may be in a range of 50:50 to 90:10.

The argyrodite type solid electrolyte may include, for example, one or more selected from Li₇-xPS₆₋ₓClx, where 0≤x≤2, Li₇-xPS₆₋ₓBrx, where 0≤x≤2, and Li₇-xPS₆₋ₓlx, where O≤x≤2. Specifically, the argyrodite type solid electrolyte may include one or more selected from the group consisting of Li₆PS₅Cl, Li₆PS₅Br, and Li₆PS_{S}l.

The solid electrolyte layer 30 may further include, for example, a binder. Examples of the binder included in the solid electrolyte layer 30 may include, but not limited to, styrene butadiene rubber (SBR), polytetrafluoroethylene, polyvinylidene fluoride, and polyethylene, and any suitable binder that is useful as a binder in the art may be used. The binder of the solid electrolyte layer 30 may be the same as or different from that of the cathode active material layer 12 or the anode active material layer 22.

### Cathode Layer

The cathode layer 10 includes a cathode current collector 11 and a cathode active material layer 12.

For example, the cathode current collector 11 may be in the form of a plate or a foil including at least one of indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof. The cathode current collector 11 may be omitted.

The cathode active material layer 12 may include, for example, a cathode active material and a solid electrolyte. The solid electrolyte included in the cathode layer 10 may be similar to or different from that in the solid electrolyte layer 30. Details of the solid electrolyte are provided in connection with the solid electrolyte layer 30. According to an embodiment, the solid electrolyte includes a solid electrolyte according to an embodiment.

The cathode layer includes a cathode active material, and the cathode active material is a compound capable of reversibly absorbing and desorbing lithium ions, for example, one or more selected from the group consisting of a lithium transition metal oxide having a layered crystal structure, a lithium transition metal oxide having an olivine crystal structure, and a lithium transition metal oxide having a spinel crystal structure. The cathode active material may include, for example, but not limited to, a lithium transition metal oxide, such as a lithium cobalt oxide (LCO), a lithium nickel oxide, a lithium nickel cobalt oxide, a lithium nickel cobalt aluminate (NCA), a lithium nickel cobalt manganate (NCM), a lithium manganate, or a lithium iron phosphate, nickel sulfide, copper sulfide, lithium sulfide, iron oxide, or vanadium oxide, and any cathode active material that is useful in the related art may be used. The cathode active material may be used alone or in a combination of two or more of the foregoing materials.

The lithium transition metal oxide may be, for example, at least one selected from compounds represented by: LiₐA_{1-b}B_{b}D₂ (where 0.90 ≤ a ≤ 1 and 0 ≤ b ≤ 0.5); LiₐE₁₋ _{b}B_{b}O_{2-c}D_{c} (where 0.90 ≤ a ≤ 1, 0 ≤ b ≤ 0.5, and 0 ≤ c ≤ 0.05); LiE_{2-b}B_{b}O_{4-c}D_{c} (where 0 ≤ b ≤ 0.5 and 0 ≤ c ≤ 0.05); LiₐNi_{1-b-c}Co_{b}B_{c}Dₐ (where 0.90 ≤ a ≤ 1, 0 ≤ b ≤ 0.5, 0 ≤ c ≤ 0.05, and 0 < α ≤ 2); LiₐNi_{1-b-c}Co_{b}B_{c}O₂₋ₐF_{α} (where 0.90 ≤ a ≤ 1, 0 ≤ b ≤ 0.5, 0 ≤ c ≤ 0.05, and 0 < α < 2); LiₐNi_{1-b-c}Co_{b}B_{c}O_{2-α}F₂ (where 0.90 ≤ a ≤ 1, 0 ≤ b ≤ 0.5, 0 ≤ c ≤ 0.05, and 0 < α < 2); LiₐNi_{1-b-c}Mn_{b}BcD_{α} (where 0.90 ≤ a ≤ 1, 0 ≤ b ≤ 0.5, 0 ≤ c ≤ 0.05, and 0 < a ≤ 2); LiₐNi_{1-b-c}Mn_{b}B_{c}O_{2-α}F_{α} (where 0.90 ≤ a ≤ 1, 0 ≤ b ≤ 0.5, 0 ≤ c ≤ 0.05, and 0 < α < 2); LiₐNi_{1-b-c}Mn_{b}B_{c}O_{2-α}F₂ (where 0.90 ≤ a ≤ 1, 0 ≤ b ≤ 0.5, 0 ≤ c ≤ 0.05, and 0 < α < 2); LiₐNi_{b}E_{c}G_{d}O₂ (where 0.90 ≤ a ≤ 1, 0 ≤ b ≤ 0.9, 0 ≤ c ≤ 0.5, and 0.001 ≤ d ≤ 0.1); LiₐNi_{b}Co_{c}Mn_{d}GeO₂ (where 0.90 ≤ a ≤ 1, 0 ≤ b ≤ 0.9, 0 ≤ c ≤ 0.5, 0 ≤ d ≤0.5, and 0.001 ≤ e ≤ 0.1); LiₐNiG_{b}O₂ (where 0.90 ≤ a ≤ 1 and 0.001 ≤ b ≤ 0.1); LiₐCoG_{b}O₂ (where 0.90 ≤ a ≤ 1 and 0.001 ≤ b ≤ 0.1); LiₐMnG_{b}O₂ (where 0.90 ≤ a ≤ 1 and 0.001 ≤ b ≤ 0.1); LiₐMn₂G_{b}O₄ (where 0.90 ≤ a ≤ 1 and 0.001 ≤ b ≤ 0.1); QO₂; QS₂; LiQS₂; V₂O₅; LiV₂O₅; LilO₂; LiNiVO₄; Li(_{3-f)}J₂(PO₄)₃ (where 0 ≤ f ≤ 2); Li(_{3-f)}Fe₂(PO₄)₃ (where 0 ≤ f ≤ 2); and LiFePO₄. In the above-listed compounds, A is Ni, Co, Mn, or a combination thereof, B is Al, Ni, Co, Mn, Cr, Fe, Mg, Sr, V, a rare earth element, or a combination thereof, D is 0, F, S, P, or a combination thereof, E is Co, Mn, or a combination thereof, F is F, S, P, or a combination thereof, G is Al, Cr, Mn, Fe, Mg, La, Ce, Sr, V, or a combination thereof, Q is Ti, Mo, Mn, or a combination thereof, I is Cr, V, Fe, Sc, Y, or a combination thereof, and J is V, Cr, Mn, Co, Ni, Cu, or a combination thereof. A compound having a coating layer added on the surface thereof and a mixture of the compound and the compound having the coating layer added thereto may also be used. Examples of the coating layer added to the surface of the compound may include a coating element compound such as an oxide or a hydroxide of the coating element, an oxyhydroxide of the coating element, an oxycarbonate of the coating element, and a hydroxy carbonate of the coating element. The compound forming the coating layer may be amorphous or crystalline. Examples of the coating element included in the coating layer may include Mg, Al, Co, K, Na, Ca, Si, Ti, V, Sn, Ge, Ga, B, As, Zr, and a mixture thereof. Any suitable coating method may be used as a coating layer forming process as long as coating may be performed using a method that does not adversely affect the physical properties of the cathode active material. The coating method may be, for example, spray coating or dipping. Details of the coating method may be well understandable by one skilled in the art, and thus a detailed description thereof will not be given.

The cathode active material may include, for example, a lithium salt of a transition metal oxide having a layered rock salt structure, among the lithium transition metal oxides. The “layered rock salt type structure” is a structure in which an oxygen atom layer and a metal atom layer are alternately regularly arranged in a <111> direction of a cubic rock salt type structure, and thus each atom layer forms a two-dimensional plane. The “cubic rock salt type structure” represents a NaCl type structure which is a kind of crystal structure, specifically a structure in which face-centered cubic lattices (fcc) formed by a cation and an anion are misaligned to each other by half (1/2) of the ridge of a unit lattice. The lithium transition metal oxide having such a layered rock salt type structure may be, for example, a ternary lithium transition metal oxide such as LiNiₓCo_{y}Al_{z}O₂ (NCA) or LiNiₓCo_{y}Mn_{z}O₂ (NCM) (where 0<x<1, 0<y<1, 0<z<1, and x+y+z=1). When the cathode active material includes the ternary lithium transition metal oxide having the layered rock salt type structure, the energy density and thermal stability of the all-solid secondary battery 1 are further improved.

As described above, the cathode active material may be covered by a coating layer. As the coating layer, any suitable coating layer that is known as the coating layer of a cathode active material in an all-solid secondary battery may be used. The coating layer may be, for example, Li₂O—ZrO₂.

When nickel (Ni) is included in the cathode active material as a ternary transition metal oxide, such as NCA or NCM, the capacity density of the all-solid secondary battery 1 may be increased, and thus the metal elution from the cathode active material in a charged state may be reduced. Consequently, cycle characteristics of the all-solid secondary battery 1 in a charged state may be improved.

The cathode active material may have a particle shape, such as a true spherical shape or an elliptical spherical shape. The particle diameter of the cathode active material is not particularly limited, and may be in a range applicable to a cathode active material for a general all-solid secondary battery. The amount of the cathode active material of the cathode layer 10 is not particularly limited but may be in a range applicable to a cathode layer of a conventional all-solid secondary battery.

In addition to the cathode active material and the solid electrolyte, the cathode layer 10 may further include, for example, a conductive agent, a binder, a filler, a dispersant, or an ion-conducting aid. The conductive agent may be, for example, graphite, carbon black, acetylene black, ketjen black, carbon fiber, or metal powder. The binder may be, for example, styrene butadien rubber (SBR), polytetrafluoroethylene, polyvinylidene fluoride, or polyethylene. The coating agent, the dispersant, or the ion-conducting aid which may be combined with the cathode layer 10 may be any material that is known as a suitable material for use in an electrode of an all-solid secondary battery.

A thickness of the solid electrolyte according to an embodiment may be 10 µm to 200 µm. When the thickness of the solid electrolyte is within the above range, high-rate and cycle characteristics of the all-solid secondary battery may be significantly improved.

In a method of preparing an all-solid secondary battery according to one or more embodiment, the all-solid secondary battery may be prepared by forming a solid electrolyte according to the above-described method, forming each of a cathode layer 10, an anode layer 20 and/or a solid electrolyte layer 30 are prepared using the thus prepared solid electrolyte, and then stacking these layers.

### Preparation of Anode Layer

For example, an anode active material, a conductive agent, a binder, and a solid electrolyte, as ingredients of the first anode active material layer 22, are added to a polar solvent or a non-polar solvent to prepare a slurry. The prepared slurry is coated on the anode current collector 21 and then dried to prepare a first laminate. Subsequently, the dried first laminate is pressed to thereby form the anode layer 20. The pressing may be, for example, but not limited to, roll pressing or flat pressing, and any suitable pressing method that is used in the art. The pressing may be omitted.

The anode layer may include an anode current collector and a first anode active material layer located on the anode current collector and including an anode active material, the anode active material may include one or more selected from a carbon-based anode active material and a metal or metalloid anode active material, and the carbon-based anode active material may include one or more selected from amorphous carbon and crystalline carbon. In addition, the metal or metalloid anode active material may be one or more selected from the group consisting of gold (Au), platinum (Pt), palladium (Pd), silicon (Si), silver (Ag), aluminum (Al), bismuth (Bi), tin (Sn) and zinc (Zn).

The anode layer may further include a second anode active material layer positioned at one or more of between the anode current collector and the first anode active material layer and between the solid electrolyte layer and the first anode active material layer, and the second anode active material layer may be a metal layer including lithium or a lithium alloy.

### Preparation of Cathode Layer

A cathode active material, a conductive agent, a binder, and a solid electrolyte, as ingredients of the cathode active material layer 12, are added to a non-polar solvent to prepare a slurry. The prepared slurry is coated on the cathode current collector 11 and then dried to obtain a laminate. The obtained laminate is pressed to thereby form the cathode layer 10. The pressing may be, for example, but not limited to, roll pressing or flat pressing, and any suitable pressing method that is used in the art. The pressing may be omitted. In another embodiment, a mixture of ingredients of the cathode active material layer 12 is compacted in a pellet form or stretched (molded) in a sheet form to prepare the cathode layer 10. When the cathode layer 10 is prepared by such a method, the cathode current collector 11 may be omitted.

### Preparation of Solid Electrolyte Layer

The solid electrolyte layer 30 includes a sulfide solid electrolyte according to an embodiment.

The solid electrolyte layer 30 may further include, in addition to the sulfide solid electrolyte, a general sulfide solid electrolyte used in an all-solid secondary battery.

For example, the general sulfide solid electrolyte may be prepared by mixing a sulfide solid electrolyte, a solvent and a binder, and coating, drying and pressing the resultant mixture. In another embodiment, the sulfide solid electrolyte prepared by the above-described method may be deposited by using a known film-forming method, such as a blasting method, an aerosol deposition method, a cold spray method, a sputtering method, a chemical vapor deposition (CVD) method, or a spray method. In another embodiment, the solid electrolyte may also be formed by pressing a solid electrolyte particle simple substance.

### Manufacture of All-Solid Secondary Battery

The cathode layer 10, the anode layer 20 and the solid electrolyte 30, which are formed by the above-described methods, are stacked such that the solid electrolyte 30 is positioned between the cathode layer 10 and the anode layer 20, and then pressed, thereby manufacturing the all-solid secondary battery 1.

For example, the solid electrolyte layer 30 is placed on the cathode layer 10 to prepare a second laminate. Next, the anode layer 20 is placed on the second laminate such that the solid electrolyte layer 30 and the first anode active material layer contact each other, to prepare a third laminate, and the third laminate is then pressed, thereby manufacturing the all-solid secondary battery 1. The pressing may be performed at a temperature of, for example, room temperature (20° C. to 25° C.) to 90° C. In another embodiment, the pressing may be performed at a high temperature of 100° C. or higher. A pressing time may be, for example, 30 minutes or less, 20 minutes or less, 15 minutes or less, or 10 minutes or less. For example, the pressing time may be 1 millisecond (ms) to 30 minutes, 1 ms to 20 minutes, 1 ms to 15 minutes, or 1 ms to 10 minutes. A pressing method may be, for example, but not limited to, isostatic pressing, roll pressing, or flat pressing, and any pressing method available in the art may be used. A pressure applied in the pressing may be, for example, 500 MPa or less, 300 MPa or less, 200 MPa or less, or 100 MPa or less.

The pressure applied in the pressing may be, for example, 50 MPa to 500 MPa, 50 MPa to 350 MPa, 50 MPa to 150 MPa, or 50 MPa to 100 MPa. Solid electrolyte particles, for example, are sintered by the pressing, thereby forming a single solid electrolyte.

The above-described constitutions and manufacturing method of the all-solid secondary battery are provided as example embodiments, and the constituent members and manufacturing processes, etc. of the all-solid secondary battery may be appropriately varied.

An embodiment of the method of preparing a sulfide-based solid electrolyte according to one or more embodiments will now be described in further detail with reference to the following Examples and Comparative Examples. Additionally, it will be understood that the following examples are only for illustrative purposes and are not intended to limit the scope of the one or more embodiments.

### Preparation of Sulfide Solid Electrolyte

### Example 1

To obtain a sulfide solid electrolyte (Li₆PS₅Cl), Li₂S, P₂S₅ and Triton X-100 (Sigma-Aldrich Co., Ltd.) were weighed according to equivalents and added to THF, thereby preparing a first mixture in the form of a suspension. An amount of THF was controlled so as to have a solid content of 10% by weight in the first mixture.

Separately from the above, Li₂S and LiCl were weighed according to equivalents to obtain a sulfide solid electrolyte (Li₆PS₅Cl) and then dissolved in ethanol, thereby preparing a second mixture. An amount of ethanol was controlled so as to have a solid content of 15% by weight in the second mixture.

An amount of Triton X-100 is 3 parts by weight, on the basis of 100 parts by weight of a total weight of Li₂S, P₂S₅, and LiCl.

The first mixture and the second mixture were mixed and stirred overnight and the thus obtained mixture was dried at 140° C. for 6 hours using a rotary evaporator. Thereafter, the dried product was subjected to heat treatment in a furnace at 500° C. under vacuum for 12 hours, thereby preparing the sulfide solid electrolyte (Li₆PS₅Cl).

### Example 2

A sulfide solid electrolyte (Li₅.₈PS₄.₈Cl₁.₂) was obtained in the same manner as in Example 1, except that amounts of Li₂S, P₂S₅ and LiCl were stoichiometrically varied so as to obtain the sulfide solid electrolyte (Li₅.₈PS₄.₈Cl₁.₂).

### Example 3

A sulfide solid electrolyte (Li₅.₈PS₄.₈Cl₁.₂) was obtained in the same manner as in Example 1, except that amounts of Li₂S, P₂S₅ and LiCl were stoichiometrically varied so as to obtain the sulfide solid electrolyte (Li₅.₈PS₄.₈Cl₁.₂) and an amount of Triton X-100 was changed to 5 parts by weight, on the basis of 100 parts by weight of a total weight of Li₂S, P₂S₅ and LiCl.

### Comparative Example 1

A sulfide solid electrolyte (Li₆PS₅Cl) was obtained in the same manner as in Example 1, except that Triton X-100 was not used in preparing a first mixture.

### Comparative Example 2

A sulfide solid electrolyte was obtained in the same manner as in Comparative Example 1, except that amounts of Li₂S, P₂S₅ and LiCl were controlled to obtain the sulfide solid electrolyte (Li₅.₈PS₄.₈Cl₁.₂).

### Comparative Example 3

Li₂S, P₂S₅ and LiCl were mixed to obtain a precursor mixture, amounts of which were stoichiometrically controlled in preparing the precursor mixture, and the amounts thereof were weighed to then be subjected to a mechanical milling process in which the mixture was mixed in a ball mill using a high energy mill equipment (Pulnerisette 7) for 20 hours. The mechanical milling process was performed at a rotation speed of 380 rpm, at 25° C. in an argon atmosphere for 20 hours.

300 mg of a powder material resulting from the mechanical milling process was subjected to heat treatment at 500° C. under vacuum for 12 hours, thereby obtaining a sulfide solid electrolyte (Li₆PS₅Cl).

When the sulfide solid electrolyte was prepared according to Comparative Example 3 through a solid-phase synthesis method, a large quantity of energy was used and quite much time was consumed. The sulfide solid electrolyte obtained by this process has a considerably uneven particle size distribution. Accordingly, in order to obtain a material having suitable particle sizes or distribution to be used as an electrolyte material for an all-solid battery, pulverization and sorting processes were additionally required.

### Comparative Example 4

A sulfide solid electrolyte was obtained in the same manner as in Example 1, except that sodium lauryl sulfate (SLS), instead of Triton X-100 (Sigma-Aldrich), was used in preparing a first mixture.

According to Comparative Example 4, the sodium lauryl sulfate is an ionic compound reacting with lithium, and particles having a very wide particle size distribution and a large size were obtained by using the same. This resulted in agglomeration of particles caused by the presence of byproducts due to side reactions, and a reduction in the ionic conductivity was observed.

### Preparation Example 1

A cathode active material having aLi₂O—ZrO₂ coating film may be prepared by the method disclosed in Korean patent publication No. 10-2016-0064942, and the cathode active material prepared in the following manner was used.

LiNi₀.₈Co₀.₁₅Mn_{0.05}O₂ (NCM) as a cathode active material, lithium methoxide, and zirconium propoxide, were stirred and mixed in a mixed solution of ethanol and ethyl acetoacetate for 30 minutes was to prepare an alcohol solution of aLi₂O—ZrO₂ (a=1) as a coating solution for coating aLi₂O—ZrO₂. Amounts of lithium methoxide and zirconium propoxide were adjusted such that the amount of aLi₂O-ZrO₂(a=1) coated on the surface of the cathode active material was 0.5 mol%.

Next, the coating solution for coating aLi₂O—ZrO₂ was mixed with fine powder of the cathode active material, and the mixed solution was heated at about 40° C. with stirring to evaporate and dry a solvent such as alcohol. Here, ultrasonic waves were irradiated into the mixed solution.

Through the above-described process, a precursor of aLi₂O—ZrO₂ was supported on particle surfaces of the cathode active material fine powder.

In addition, the aLi₂O—ZrO₂ (a=1) precursor supported on the particle surfaces of the cathode active material powder was thermally treated at about 350° C. in an oxygen atmosphere for one hour. During the thermal treatment process, the aLi₂O—ZrO₂ (a=1) precursor existing on the cathode active material was changed to aLi₂O—ZrO₂ (a=1). An amount of Li₂O-ZrO₂ (LZO) was about 0.4 parts by weight, on the basis of 100 parts by weight of NCM.

Through the above-described preparation process, the LiNi₀.₈Co₀.₁₅Mn_{0.05}O₂ (NCM) having the aLi₂O—ZrO₂ coating film was obtained. In aLi₂O—ZrO₂, a is 1.

### Manufacture of All-Solid Secondary Battery

### Example 4

### (Cathode Layer)

LiNi₀.₈Co₀.₁₅Mn_{0.05}O₂ (NCM) coated with Li₂O-ZrO₂ (LZO) obtained in Preparation Example 1, was prepared as a cathode active material.

Sulfide solid electrolyte powder prepared in Example 1 was prepared as a solid electrolyte. Carbon nanofiber (CNF) was prepared as a conductive agent. The prepared materials, that is, the cathode active material, the solid electrolyte and the conductive agent, were mixed at a weight ratio of 60:35:5, and the mixture was molded in a large sheet form, thereby preparing a cathode sheet. The prepared cathode sheet was compressed on a cathode current collector made of a 18 µm thick carbon coated aluminum foil, thereby preparing a cathode layer. A thickness of the prepared cathode active material layer was about 100 µm.

### (Anode Layer)

As an anode layer, an about 30 µm thick lithium metal was used.

### (Solid Electrolyte Layer)

To a crystalline agyrodite-based solid electrolyte (Li₆PS₅Cl) was added 1 part by weight of a styrene-butadiene rubber (SBR) binder on the basis of 100 parts by weight of the solid electrolyte, to prepare a mixture. Xylene and diethylbenzene were added to the mixture and stirred to prepare a slurry. The prepared slurry was coated on a nonwoven fabric using a blade coater and dried at a temperature of 40° C. in the air to obtain a laminate. The obtained laminate was dried at 40° C. under vacuum for 12 hours. Through the above-described process, the solid electrolyte layer was prepared.

The solid electrolyte layer was positioned on the anode layer, and the cathode layer was positioned on the solid electrolyte layer to prepare a laminate. The prepared laminate was subjected to plate-pressing treatment at 25° C. with a pressure of 100 MPa for 10 minutes. The solid electrolyte layer was sintered by the pressing treatment, and thus the battery characteristic was improved.

### Example 5-6

All-solid secondary batteries were manufactured in the same manner as in Example 4, except that the solid electrolyte prepared in Example 1 was changed to the solid electrolytes prepared in Examples 2 and 3 in cathode layers.

### Comparative Example 5

An all-solid secondary battery was manufactured in the same manner as in Example 4, except that the solid electrolyte prepared in Example 1 was changed to the solid electrolyte prepared in Comparative Example 1 in a cathode layer and a solid electrolyte.

### Evaluation Example 1: Scanning Electron Microscopy (SEM)

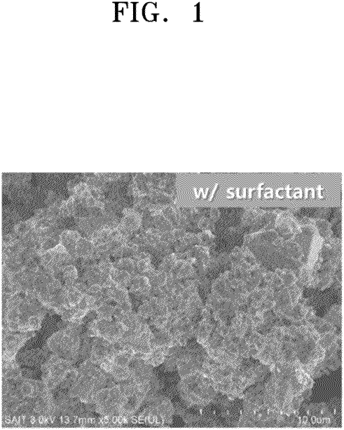

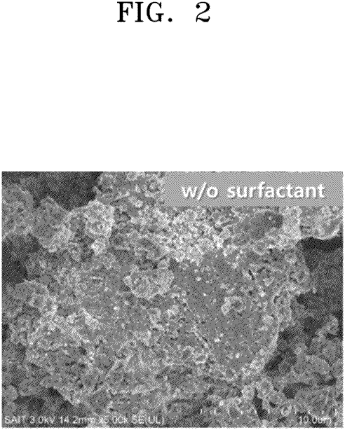

The sulfide solid electrolyte particles prepared in Example 1 and Comparative Example 1 were analyzed by SEM, and the results are shown in FIGS. 1 and 2. SU8030 manufactured by Hitachi was used as a scanning electron microscope.

The sulfide solid electrolyte of Comparative Example 1, as shown in FIG. 2, had particles of several tens of micrometers (µm) in size, and it was observed that the particles agglomerated together or interconnected without interstices therebetween, forming a network shape.

However, as shown in FIG. 1, the sulfide solid electrolyte of Example 1 had small sized particles, uniformly distributed with little agglomeration. This analysis result is consistent with the result of Evaluation Example 3 for particle size and distribution characteristics.

### Evaluation Example 2: X-Ray Diffraction Spectrum (XRD) Analysis

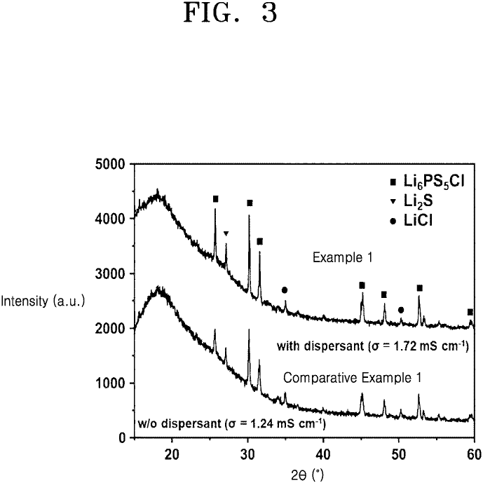

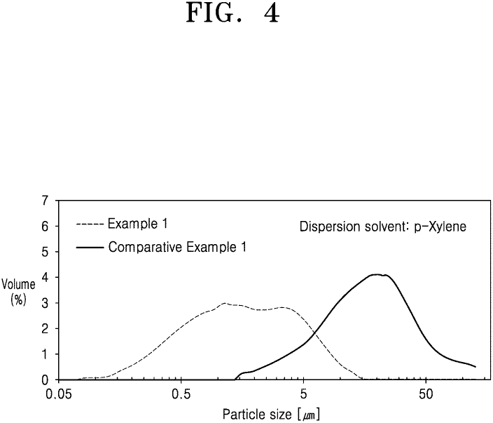

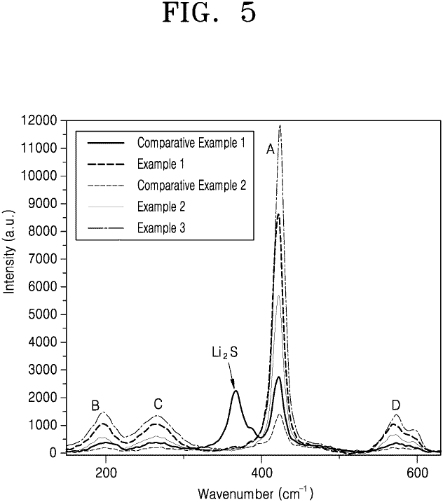

XRD spectra of the solid electrolytes prepared in Example 1 and Comparative Example 1 were measured, and the results thereof are shown in FIG. 3. X-ray diffraction was performed using D8 Advance manufactured by Bruker AXS, and CuKα radiation was used in measuring XRD spectra.

Referring to FIG. 1, it was confirmed that the sulfide solid electrolyte of Example 1 has an argyrodite crystal structure, like in Comparative Example 1. In the Raman spectroscopy analysis for the sulfide solid electrolyte of Example 1, it was found that intensities of peaks at a diffraction angle (2θ) of 25 degrees (°), 28° or 30° were increased, confirming that the sulfide solid electrolyte of Example 1 had increased crystallinity, as compared with the solid electrolyte of Comparative Example 1.

### Evaluation Example 3: Particle Size and Distribution

D10, D50 and D90 of the sulfide solid electrolyte particles prepared in Example 1 and Comparative Example 1 were investigated. Particle diameters of the sulfide solid electrolyte were measured using a laser diffraction type particle size analyzer (Microtrac Bluewave Wet System, commercially available from Dream Corporation). In addition, p-xylene was used as a dispersing solvent of the particles.

D10, D50, and D90 mean particle diameters in which a cumulative volume percentage in a volume particle size distribution are 10% by volume, 50% by volume, and 90% by volume, respectively.

The measurement results of D10, D50 and D90 are indicated in Table 3.

The relative span factor (R.S.F) for the particle size distribution is calculated in the following equation.

$$\text{R} \text{.S} \text{.F} \text{=} \left(\text{D90-D10}\right) / \text{D50} \qquad \text{<Equation 1>}$$

TABLE 3

| | | | | | |
|---|---|---|---|---|---|
| Data | D10 (µm) | D50 (µm) | D90 (µm) | D90-D10 (µm) | R.S.F |
| Example 1 | 0.37 | 1.49 | 5.41 | 5.04 | 3.38 |
| Example 2 | 0.56 | 1.88 | 6.19 | 5.63 | 3.0 |
| Example 3 | 0.62 | 3.53 | 10.33 | 9.71 | 2.75 |
| Comparative | 4.91 | 16.50 | 46.73 | 41.83 | 2.53 |
| Example 1 | | | | | |

Referring to Table 3, the sulfide solid electrolyte particles of Example 1 were prepared using a solution-phase synthesis method, and were found to have a relatively small average particle diameter (D50) over a narrow, uniform particle size distribution, as compared with the sulfide solid electrolyte particles of Comparative Example 1 using a solid-phase synthesis method.

In addition, the sulfide solid electrolyte of Example 1 includes particles having a relatively small size and a uniform distribution without additional post-treatment, such as classification, as compared with the sulfide solid electrolyte particles prepared using a general solution-phase synthesis method.

### Evaluation Example 4: Raman Spectroscopy Analysis

The sulfide solid electrolytes of Examples 1 to 3 and Comparative Examples 1 and 2 were analyzed by Raman spectroscopy. The Raman spectroscopy analysis was performed using a laser diffraction type particle size analyzer (Microtrac Bluewave Wet System, commercially available from Dream Corporation).

I_{A}/I_{B}, I_{A}/I_{c} and I_{A}/I_{D} were investigated from Raman spectra and the results thereof are indicated in Tables 4 and 5.

The central wavenumber of the peak A appears at 422 cm⁻¹, the central wavenumber of the peak B appears at 197 cm⁻¹, the central wavenumber of the peak C appears at 265 cm⁻¹, and the central wavenumber of the peak D appears at 572 cm⁻¹. The central wavenumber is a wavenumber at which each peak shows the maximum intensity. In Table 4, I_{A}/I_{B} is an intensity of the peak A/an intensity of the peak B, I_{A}/I_{C} is an intensity of the peak A/an intensity of the peak C, and I_{A}/I_{D} is an intensity of the peak A/an intensity of the peak D.

TABLE 4

| Data | Comparative Example 1 | Example 1 | Comparative Example 2 | Example 2 | Example 3 |
|---|---|---|---|---|---|
| | Cl-3 (ref) | Cl-4 (3 wt%) | Cl1.2-6 (ref) | Cl1.2-3 (3 wt%) | Cl1.2-5 (5 wt%) |
| I_{A}/I_{B} | 7.386842 | 8.249409 | 7.81808 | 10.56714 | 8.328832 |
| I_{A}/I_{C} | 7.576248 | 8.301998 | 6.860921 | 9.484401 | 9.181926 |
| I_{A}/I_{D} | 7.429857 | 8.381748 | 7.609995 | 8.487877 | 8.773115 |
| FWHM (cm⁻¹) of peak A | 17.5 | 16.2 | 18.3 | 15.3 | 14.9 |

As shown in FIG. 5, the sulfide solid electrolytes of Examples 1 to 3 showed relatively strong intensities of the peak A, compared to those of Comparative Examples 1 and 2. By contrast, in the sulfide solid electrolytes of Comparative Examples 1 and 2, the peak A was relatively weak, and the peaks B, C and D were relatively strong. In addition, as confirmed from Table 1, I_{A}/I_{B}, I_{A}/I_{C} and I_{A}/I_{D} were all 8 or greater, indicating that the sulfide solid electrolytes of Examples 1 to 3 had increased intensity ratios, compared to those of Comparative Examples 1 and 2. In addition, the sulfide solid electrolytes of Examples 1 to 3 were found to have a reduced full width at half maximum (FWHM) of the peak A, compared to those of Comparative Examples 1 and 2.

From this finding, it was observed that the sulfide solid electrolytes of Examples 1 to 3 had a relatively high intensity at the peak A, indicating that a highly ionically conductive material has a high ionic conductivity because of Li₃PS₄ included as a main component. However, in Comparative Examples 1 and 2, Li₃PS₄ was not a main component and P2S6⁴⁻ or P2S7⁴⁻ having a low ionic conductivity may further be included, indicating that ionic conductivities of the sulfide solid electrolytes of Comparative Examples 1 and 2 were not higher than those of the sulfide solid electrolytes of Examples 1 to 3.

### Evaluation Example 5: Measurement of Ionic Conductivity

The sulfide solid electrolyte powders of Example 1 and Comparative Example 1 were put into a mold having a diameter of 10 mm and pressed under a pressure of 350 mPa to then be molded into pellets. Then, an indium (In) foil was coated on opposite sides of each pellet to prepare a sample for measuring an ionic conductivity. An impedance of each sample was measured using a potentiostat (AUTOLAB PGSTAT30, commercially available from Metrohm Autolab Co. Ltd.) to plot Nyquist plots, and an ionic conductivity at 25° C. was obtained from the Nyquist plots.

The obtained ionic conductivities are shown in Table 5.

TABLE 5

| Data | Ionic conductivity (mS/cm) (@ 25° C.) |
|---|---|
| Example 1 | 1.72 |
| Comparative Example 1 | 1.07 |

As shown in Table 1, the sulfide solid electrolytes of Example 1 was found to have an improved ionic conductivity at room temperature (25° C.), as compared with the sulfide solid electrolytes of Comparative Example 1.

### Evaluation Example 4: Charge-discharge Characteristics

Charge-discharge characteristics of the all-solid secondary battery of Example 4 using the sulfide solid electrolyte of Example 1 and the all-solid secondary battery of Comparative Example 5 using the sulfide solid electrolyte of Comparative Example 1 were evaluated by the following charge-discharge test.

Charge-discharge tests of the all-solid secondary batteries were performed in a 25° C. thermostatic bath.

The all-solid secondary battery was charged with a constant current of 0.1 C for 10 hours until a battery voltage reached 4.25 volts (V), and then discharged with a constant current of 0.05 C for 20 hours until a battery voltage reached 2.5 V (First cycle). Next, the battery was charged with a constant current of 0.1 C for 10 hours until a battery voltage reached 4.25 V, and then discharged with a constant current of 0.33 C for three hours until a battery voltage reached 2.5 V (Second cycle). Thereafter, the battery was charged with a constant current of 0.1 C for 10 hours until a battery voltage reached 4.25 V. Subsequently, the battery was discharged with a constant current of 0.5 C for two hours until a battery voltage reached 2.5 V (Third cycle). Then, the battery was charged with a constant current of 0.1 C for 10 hours until a battery voltage reached 4.25 V. Next, the battery was discharged with a constant current of 1 C for one hour until a battery voltage reached 2.5 V (Fourth cycle). Thereafter, the battery was charged with a constant current of 0.1 C for 10 hours until a battery voltage reached 4.25 V. Subsequently, the battery was discharged with a constant current of 0.5 C for 10 hours until a battery voltage reached 2.5 V (Fifth cycle).

Thereafter, the battery was charged with a constant current of 0.33 C for three hours until a battery voltage reached 4.25 V, and then discharged with a constant current of 0.33 C for three hours until a battery voltage reached 2.5 V.

The charge-discharge cycles were repeatedly performed a total of 100 times, and changes in the capacity depending on the number of cycles and capacity retention ratios were evaluated, respectively. The capacity retention ratio was calculated using the following Equation 2:

$$\begin{matrix}\text{Capacity retention ratio} \left(\%\right) = \\ \left(\text{Discharge capacity of each cycle} / \text{Discharge capacity of first cycle}\right) \\ \times 100\end{matrix} \qquad \text{<Equation 2>}$$

The all-solid secondary battery of Example 4 had an excellent discharge capacity and an improved capacity retention ratio, as compared with the all-solid secondary battery of Comparative Example 4.

By using the method of preparing a sulfide solid electrolyte according to an aspect, a sulfide solid electrolyte having a uniform particle size distribution without particle agglomeration can be obtained and a large-scale production thereof can be achieved. In addition, by using the sulfide solid electrolyte, an electrochemical cell having improved cycle characteristics while having an excellent ionic conductivity, can be manufactured.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

1. A method of preparing a sulfide solid electrolyte, the method comprising:
preparing a precursor mixture by mixing raw materials for forming a sulfide solid electrolyte containing lithium with an organic compound, wherein the organic compound is non-reactive with lithium and is a non-ionic material having a hydrophobic region and a hydrophilic region;
removing a solvent from the precursor mixture; and
performing heat-treatment on the resultant product having the solvent removed therefrom.

2. The method of claim 1, wherein the organic compound is a non-ionic compound having a polyethylene oxide-based unit.

3. The method of claim 1, wherein the organic compound is octoxinol, polyoxyethylene sorbitan fatty acid ester, polyoxyethyleneglycol ether, or a combination thereof.

4. The method of claim 3, wherein the polyoxyethylene ether is polyoxyethylene(4) lauryl ether, polyoxyethylene (23) lauryl ether, polyoxyethylene (2) cetyl ether, polyoxyethylene (10) cetyl ether, polyoxyethylene (20) cetyl ether, polyoxyethylene (2) stearyl ether, polyoxyethylene (10) stearyl ether, polyoxyethylene (20) stearyl ether, polyoxyethylene (2) oleyl ether, polyoxyethylene (2) oleyl ether, polyoxyethylene (10) oleyl ether, polyoxyethylene (20) oleyl ether, polyoxyethylene (100) stearyl ether, or a combination thereof, and
the polyoxyethylene sorbitan fatty acid ester is polyoxyethylene (20) sorbitan monolaurate, polyoxyethylene (20) sorbitan monopalmitate, polyoxyethylene sorbitan monostearate, polyoxyethylene sorbitan tristearate, polyoxyethylene (20) sorbitan monooleate, polyoxyethylene sorbitan trioleate, polyoxyethylene monostearate, or a combination thereof.

5. The method of claim 1, wherein an amount of the organic compound is 0.5 parts by weights to 10 parts by weight, on the basis of 100 parts by weight of a total amount of the raw materials for forming a sulfide solid electrolyte containing lithium.

6. The method of claim 1, wherein the sulfide solid electrolyte is a compound represented by Formula 1 below, and
the raw materials comprise sulfur (S) precursor, phosphorus (P) precursor, and an X precursor: 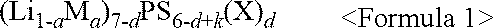
wherein, in Formula 1, M is sodium (Na), potassium (K), calcium (Ca), iron (Fe), magnesium (Mg), silver (Ag), zirconium (Zr), zinc (Zn), or a combination thereof,
X is chlorine (CI), bromine (Br), fluorine (F), iodine (I), a pseudohalogen, or a combination thereof, 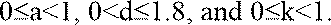
.

7. The method of claim 1, wherein an M precursor is further added in preparing the precursor mixture, and
M in the M precursor is sodium (Na), potassium (K), calcium (Ca), iron (Fe), magnesium (Mg), silver (Ag), zirconium (Zr), zinc (Zn), or a combination thereof.

8. The method of claim 1, wherein the heat treatment is performed at 300° C. to 600° C.

9. The method of claim 1, wherein the raw materials for forming a sulfide solid electrolyte containing lithium comprise a sulfur (S) precursor, a phosphorus (P) precursor, and a halogen X precursor, and
the preparing of the precursor mixture comprises: obtaining a first mixture by mixing the sulfur precursor and the phosphorus precursor with a first solvent; obtaining a second mixture by mixing lithium, the sulfur precursor, and the X halogen precursor with a second solvent; and mixing the first mixture and the second mixture.

10. The method of claim 9, wherein the first solvent is one or more selected from the group consisting of tetrahydrofuran, acetonitrile, butylacetate, N-ethylacetate, N-methylformamide, heptane, and xylene, and
the second solvent is one or more selected from the group consisting of ethanol, methanol, propanol, acetonitrile, ethylpropionate, heptane, and xylene.

11. A sulfide solid electrolyte comprising
a compound represented by Formula 1 below and having an argyrodite crystal structure, wherein
the compound has a D50 of 0.9 µm to 5.0 µm, a D10 of 0.1 µm to 0.8 µm, and a D90 of 3 µm to 20 µm, a relative span factor (R.S.F) of a particle size distribution is 10 or less: 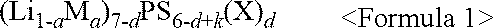
wherein, in Formula 1, M is sodium (Na), potassium (K), calcium (Ca), iron (Fe), magnesium (Mg), silver (Ag), zirconium (Zr), zinc (Zn), or a combination thereof,
X is chlorine (Cl), bromine (Br), fluorine (F), iodine (I), a pseudohalogen, or a combination thereof, 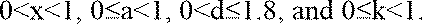
.

12. The sulfide solid electrolyte of claim 11, wherein in Raman spectroscopy analysis of the compound, an intensity ratio (I_{A}/I_{B}) of a peak A appearing at a wavenumber of 380 cm⁻¹ to 480 cm⁻¹ and a peak B appearing at a wavenumber of 130 cm⁻¹ to 220 cm⁻¹ is 8 or greater.

13. The sulfide solid electrolyte of claim 11, wherein in Raman spectroscopy analysis of the compound, a full width at half maximum (FWHM) of a peak A appearing at a wavenumber of 380 cm⁻¹ to 480 cm⁻¹ is 10 cm⁻¹ to 20 cm⁻¹.

14. The sulfide solid electrolyte of claim 11, wherein in Raman spectroscopy analysis of the compound, an intensity ratio (I_{A}/I_{C}) of a peak A appearing at a wavenumber of 380 cm⁻¹ to 480 cm⁻¹ and a peak C appearing at a wavenumber of 220 cm⁻¹ to 320 cm⁻¹ is 8 or greater.

15. The sulfide solid electrolyte of claim 11, wherein in Raman spectroscopy analysis of the compound, an intensity ratio (I_{A}/I_{D}) of a peak A appearing at a wavenumber of 380 cm⁻¹ to 480 cm⁻¹ and a peak D appearing at a wavenumber of 520 cm⁻¹ to 620 cm⁻¹ is 8 or greater.

16. The sulfide solid electrolyte of claim 11, wherein in Raman spectroscopy analysis of the compound, the intensity ratio (I_{A}/I_{B}) of a peak A appearing at a wavenumber of 380 cm⁻¹ to 480 cm⁻¹ and a peak B appearing at a wavenumber of 130 cm⁻¹ to 220 cm⁻¹ is in the range of 8 to 15,
the intensity ratio (I_{A}/I_{C}) of the peak A and a peak C appearing at a wavenumber of 220 cm⁻¹ to 320 cm⁻¹ is in the range of 8 to 10, and
the intensity ratio (I_{A}/I_{D}) of the peak A and a peak D appearing at a wavenumber of 520 cm⁻¹ to 620 cm⁻¹ is in the range of 8 to 10.

17. An electrochemical cell comprising:
a cathode layer; an anode layer; and a solid electrolyte layer positioned between the cathode layer and the anode layer, wherein
at least one selected from the cathode layer; the anode layer; and the solid electrolyte layer comprises the sulfide solid electrolyte of claim 11.

18. The electrochemical cell of claim 17, wherein the cathode layer comprises a solid electrolyte including a compound represented by Formula 1 below and having an argyrodite crystal structure, wherein
the compound has a D50 of 0.9 µm to 5.0 µm, a D10 of 0.1 µm to 0.8 µm, and a D90 of 3 µm to 20 µm: 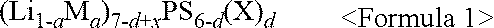
wherein, in Formula 1, M is sodium (Na), potassium (K), iron (Fe), magnesium (Mg), silver (Ag), zirconium (Zr), zinc (Zn), or a combination thereof, X is chlorine (Cl), bromine (Br), fluorine (F), iodine (I), a pseudohalogen, or a combination thereof, 0≤a<1, and 0<d≤1.8.

19. The electrochemical cell of claim 17, wherein the anode layer comprises an anode current collector and a first anode active material layer including an anode active material located on the anode current collector,
the anode active material includes one or more selected from the group consisting of a carbon-based anode active material and a metal or metalloid anode active material,
a second anode active material layer is further positioned at one or more of between the anode current collector and the first anode active material layer and between the solid electrolyte layer and the first anode active material layer, and
the second anode active material layer is a metal layer including lithium or a lithium alloy.

20. The electrochemical cell of claim 17, wherein the electrochemical cell is an all-solid secondary battery.
